(19) United States
(12) Patent Application Publication
(10) Pub. No.: US 2019/0102715 A1
(43) Pub. Date: Apr. 4, 2019

(54) METHODS AND DEVICES FOR MANAGING RESOURCE REALLOCATION

(71) Applicant: The Toronto-Dominion Bank, Toronto (CA)

(72) Inventors: Nasim SARIR, Thornhill (CA); Peter HORVATH, Toronto (CA); Maryam KARBASI, Toronto (CA); Arun Victor JAGGA, Toronto (CA); John Jong-Suk LEE, Toronto (CA); Steven Gervais, Newmarket (CA)

(21) Appl. No.: 15/724,464

(22) Filed: Oct. 4, 2017

(51) Int. Cl. G06Q 10/06; G06F 9/50; H04L 29/08; H04L 12/24

(52) U.S. Cl. CPC G06Q 10/06312; G06Q 10/06315; H04L 41/22; H04L 67/32; G06F 9/5077

(57) ABSTRACT

A computer system and computer-implemented method for proactively enabling reallocation of resources among two or more data records. The data records include a first data record to which resources are allocated. The system includes determining that the resources allocated to the first data record include surplus resources and sending a notification to a manager application on a remote device, the notification including a proposed reallocation of at least a portion of the surplus resources to a second data record. The manager application is associated with both the first data record and the second data record. A response is received from the remote device confirming the proposed reallocation and, in response, the at least a portion of the surplus resources are reallocated from the first data record to the second data record.

### TECHNICAL FIELD

The present application relates to resource allocation and, in particular, to methods and device for managing resource reallocation.

### BACKGROUND

The concept of optimal resource allocation finds application in a number of fields. For example, in the case of computer science, resource allocation may be the allocation of processor time or processor cycles among two or more active processes or threads. In some cases, it may involve allocating bandwidth among two or more users, processes, devices or systems. Some applications involve allocating non-computing resources.

The dynamic reallocation of resource among active processes may be a straightforward rebalancing of resource allocation based on live real-time consumption; however, this is not the case when resources are assigned to one or more data records (or users or applications, etc.) from which the resources may be consumed in the future. Moreover, in many cases it may not be possible to automate the reallocation due to the requirement of first receiving administrator approval for the reallocation. This may be due to regulations, policies, security, network stability, or for other purposes.

It would be advantageous to provide for a system and method that facilitates proactive reallocation of resources.

### BRIEF DESCRIPTION OF THE DRAWINGS

Embodiments are described in detail below, with reference to the following drawings:

FIG. 1 diagrammatically shows an example computing system for proactively reallocated resources;

FIG. 2 shows, in flowchart form, one example method for reallocating resources;

FIG. 3 shows another example method for reallocating resources;

FIG. 4 shows a first example method of identifying surplus resources;

FIG. 5 shows a second example method of identifying surplus resources;

FIG. 6 shows a third example method of identifying surplus resources;

FIG. 7 shows an example user interface of a manager application;

FIG. 8 shows an example notification of proposed reallocation on a lockscreen;

FIG. 9 shows a simplified block diagram of an example server; and

FIG. 10 shows a simplified block diagram of an example remote device.

Like reference numerals are used in the drawings to denote like elements and features.

### DETAILED DESCRIPTION OF VARIOUS EMBODIMENTS

In one aspect, the present application describes a system for proactively enabling reallocation of resources among two or more data records. The system includes a processor; memory coupled to the processor and storing the two or more data records, wherein the data records include a first data record to which resources are allocated; and a resource allocation system. The resource allocation system includes processor executable instructions stored in the memory that, when executed, cause the processor to determine that the resources allocated to the first data record include surplus resources, send a notification to a manager application on a remote device, the manager application being associated with the first data record, the notification including a proposed reallocation of at least a portion of the surplus resources to a second data record associated with the manager application, and receive a response confirming the proposed reallocation and, in response, reallocate the at least a portion of the surplus resources from the first data record to the second data record.

In another aspect, the present application describes a computer-implemented method of proactively enabling reallocation of resources among two or more data records, the data records include a first data record to which resources are allocated. The method includes determining that the resources allocated to the first data record include surplus resources; sending a notification to a manager application on a remote device, the manager application being associated with the first data record, the notification including a proposed reallocation of at least a portion of the surplus resources to a second data record associated with the manager application; and receiving a response confirming the proposed reallocation and, in response, reallocating the at least a portion of the surplus resources from the first data record to the second data record.

In another aspect, a non-transitory computer-readable medium storing processor-executable instructions that, when executed, cause a processor to carry out the operations of one or more methods described herein.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

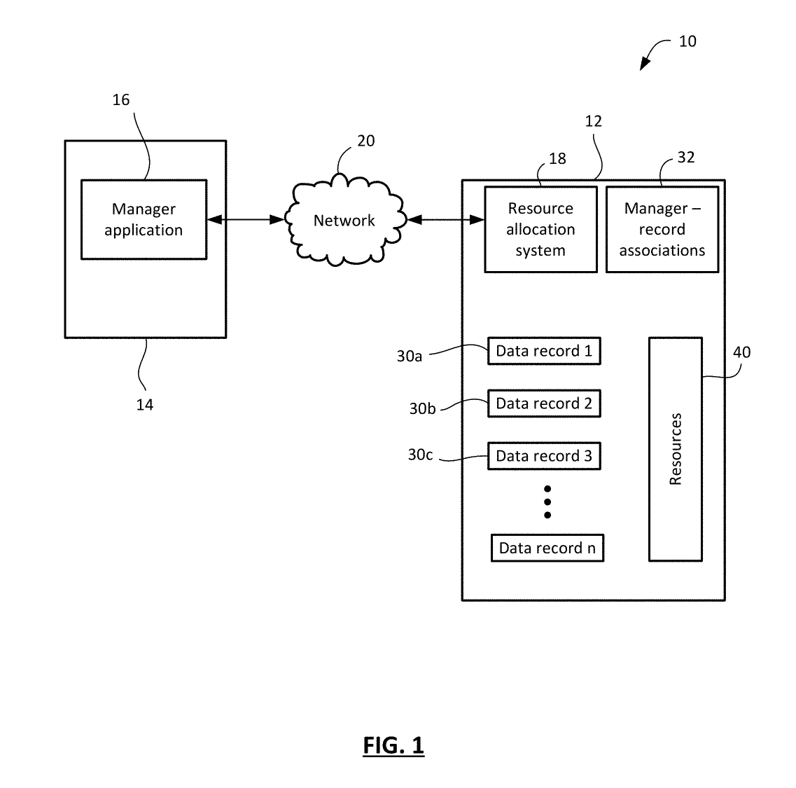

Reference is first made to FIG. 1, which shows, in block diagram form an example system 10 for managing resource allocation. The system 10 includes a server 12 that implements a resource allocation system 18. The server 12 may be a single server, multiple servers, a server farm, or any other such arrangement of computing devices to implemented server-like functionality. It will be appreciated that the server 12 includes one or more processors and memory.

The server 12 is configured to communicate over a network 20 with remote devices, such as example remote device 14. The network 20 may include a plurality of interconnected wired and wireless networks, including the Internet, wireless local area networks, wireless area networks, and the like. The remote device 14 is a computing device having one or more processors, memory and communication capabilities. In some examples, the remote device 14 is a mobile device such as a smartphone or a tablet, a personal computer, a desktop computer, a smartwatch, or any similar computing device.

The server 12 includes a plurality of data records 30 (shown individually as 30a, 30b, 30c, etc.). The data records 30 may be characterized as data structures having unique identifiers in some cases. In some examples, each data record 30 may be a separate process or application. In some examples, each data record 30 may be a “bucket” or storage area in memory on the server 12. In some examples, each data record 30 may be an account or record associated with a specific user (or manager, as will be explained below).

The server 12 includes resources 40 (shown as a single item in FIG. 1 for ease of illustration). Resources 40 may be added to or removed from the server 12. More particularly, the resources 40 may be allocated among the plurality of data records 30. That is, each data record 30 may have a particularly quantity of resources 40 allocated to it. Resources 40 may be added to or removed from a data record 30, with the authorization of a manager of that data record 30. Associations 32 between managers and data records may be stored on the server 12.

Resources 40 may include, for example, computing resources such as processor cycles, processor time, memory, bandwidth, or the like. The resources 40 may be stored in association with the various data records 30 for consumption by that data record 30 or for reallocation from that data record 30 to other data records 30 on the server 12 or to applications or processes external to the server 12. In some examples, the resources 40 may include other consumables, such as, generically, tokens or digital assets. Tokens may represent any quantifiable thing, including money, credits, shares, cryptocurrency, time, precious metals, etc.

The resource allocation system 18 on the server 12 manages the allocation and reallocation of resources 40 among the data records 30 and, in particular, ensures the security and integrity of the ledger of resources 40 and data records 30. The resource allocation system 18 may provide a number of functions including communicating with external systems that query resource availability, request transfers of resources into or out of the data records 30, or otherwise deal with the resources 40 and data records 30. It will be appreciated that a significant function of the resource allocation system 18 is to ensure that only an authorized manager of a data record 30 is permitted to obtain information regarding the data record 30 or the resources 40 allocated to the data record 30 and to perform actions with respect to those resources 40. To do so, the server 12 and the resource allocation system 18 implement various security, authentication and verification protocols to ensure that communications from a remote system are validated and authenticated before granting any access or action privileges.

The remote device 14 stores and executes a manager application 16 for connecting with the server 12 and interacting with the resource allocation system 18. The manager application 16 permits an authenticated manager to take actions with respect to the data records 30 with which the authenticated manager is associated. This may include transferring resources 40 from one associated data record 30 to another associated data record 30. This may include injecting additional resources 40 from an external source to one of the associated data records 30. This may include transferring resources 40 from a data record 30 to an external entity or location. It will be appreciated that a manager may have more than one manager application 16 on more than one remote device 14, so that the manager may access data records 30 through multiple devices.

In some implementations, the resource allocation system 18 may rely on each individual manager to determine and implement the resource allocation considered suitable for that manager's data records via that manager's manager application 16. A given manager would log into the server 12 via the manager application 16 over the network 20 to access information regarding that manager's associated data records 30 and their respective allocations. The manager may then, using the manager application 16, move resources from one data record 30 to another.

However, in one aspect of the present application, the resource allocation system 18 identifies potential reallocation opportunities and proactively notifies the associated manager application 16. In doing so, the resource allocation system 18 may, in concert with the manager application 16, facilitate quick authentication and approval of the proposed reallocation of resources 40 so as to implement the change on a timely basis with a reduced number of operations required of the remote device 14.

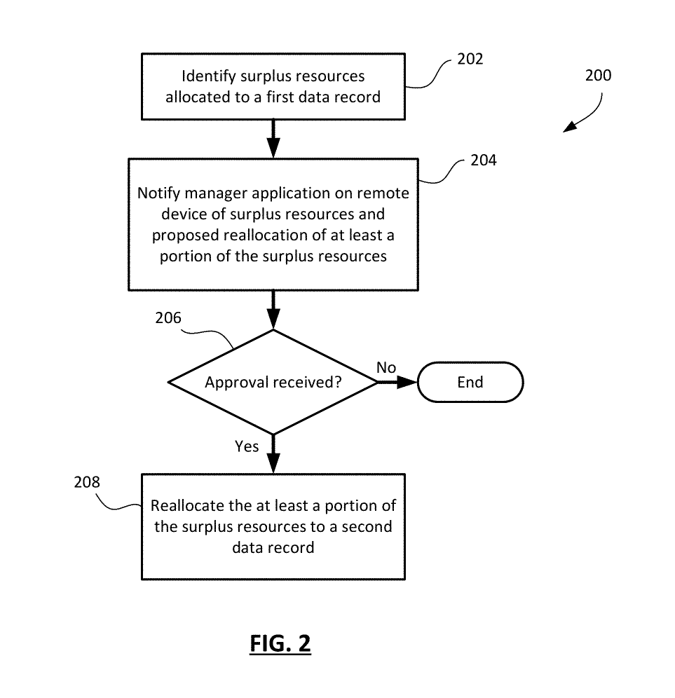

Reference is now made to FIG. 2, which shows, in flowchart form, one example method 200 of proactively reallocating resources. The method 200 begins in operation 202 with the resource allocation system 18 (FIG. 1) identifying surplus resources allocated to a first data record. The identification of surplus resource may include various analyses, some of which are described in examples below. In operation 204, the resource allocation system 18 notifies an associated manager application on a remote device that surplus resources are allocated to the first data record and proposes a reallocation of at least a portion of the surplus resources. The notification may include transmitting a secure message to the remote device, and the manager application in particular, specifying the surplus resources, the data record to which they are allocated, and the data record to which the portion is proposed to be reallocated. The reallocation may be presented at the remote device in the form of a pre-configured transfer operation.

In operation 206, the resource allocation system 18 determines whether the proposed reallocation is approved based on a response from the remote device. If the reallocation is declined, the method 200 ends. If the reallocation is approved, then in operation 208 the resource allocation system 18 reallocates the portion of the surplus resources to a second data record.

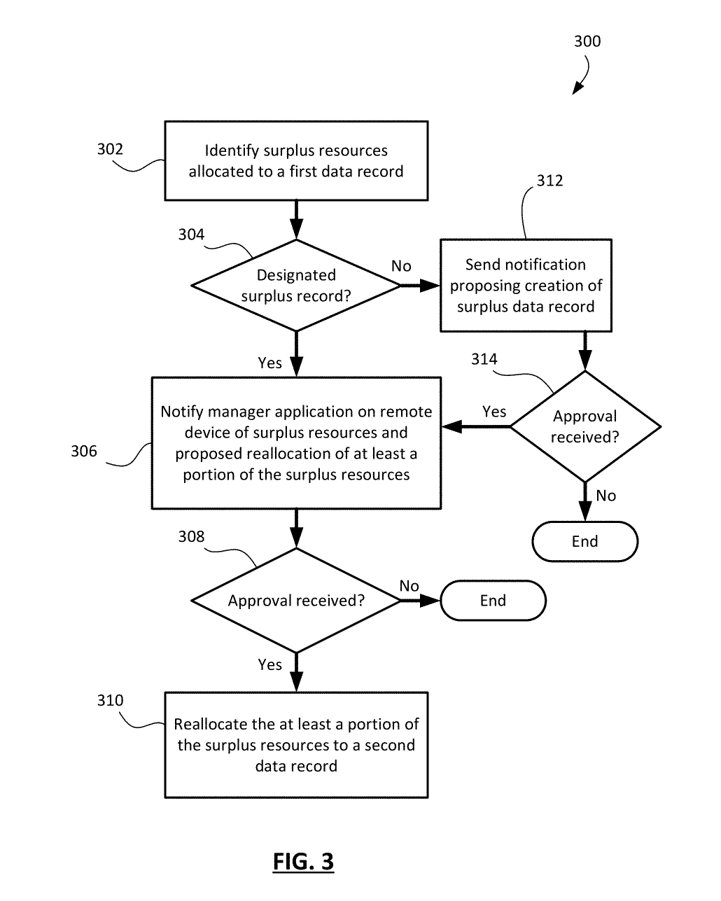

The second data record may be a data record pre-designated for surplus resources in some cases. In some cases, no second data record may be associated with the manager of the first data record, or at least not one designated for surplus resources. In this case, the resource allocation system may include in its notification the option of generating such a data record on the server. An example is shown in FIG. 3, which shows, in flowchart form, another example method 300 for proactively reallocating resources.

In this method 300, as before, the resource allocation system identifies surplus resources allocated to a first data record in operation 302. The system then determines whether the manager associated with the first data record has a second data record designated for surplus resources, as indicated by operation 304. If so, then it may proceed as described before by sending a notification to the remote device proposing reallocation of at least a portion of the surplus resources to the second data record, as shown in operation 306.

If there is not a designated second data record for surplus funds, then the system may, in operation 312, send a notification proposing creation of such a data record (or designation of an existing data record) as the data record for surplus resources. The notification may provide details of the proposed reallocation or may simply indicate that surplus resources have been identifies and propose designation of a data record for surplus resources. The notification is sent to the remote device(s) having a manager application associated with the first data record. In response, a message is received either approving or canceling the proposal to create a second data record. In some cases, further exchange of information may take place in the course of setting up and confirming the creation of the second data record. As indicated by operation 314, if creation of the second data record (or designation of an existing data record as the second data record) is confirmed and approved, then the method 300 proceeds to operation 306 to send the proposed reallocation notification.

As before, if an approval response is received in operation 308, then the method 300 proceeds to operation 310 to implement the proposed reallocation. Otherwise, the method 300 ends.

As indicated above, the resource allocation system monitors the data records and identifies if a data record has an allocation of resources that includes surplus resources. The identification of surplus resources may be made using a range of possible analyses. In one example embodiment, the identification of a surplus is based on a predefined threshold level of resources, above which the excess is identified as surplus resources.

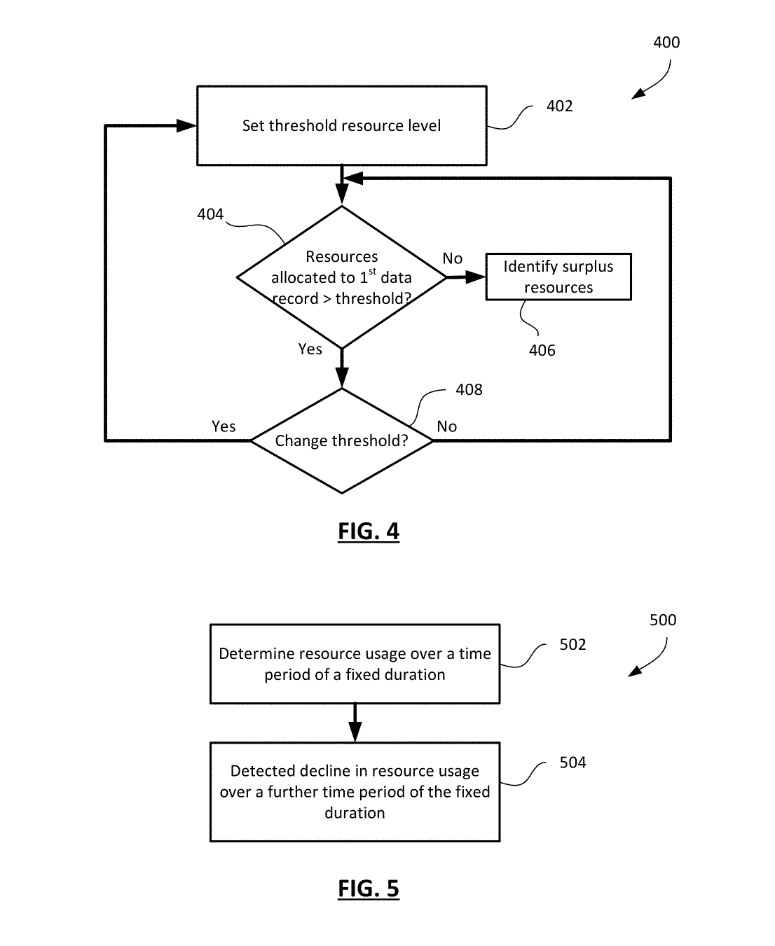

FIG. 4 shows, in flowchart form, one example method 400 of identifying surplus resources. In this example, in operation 402 a threshold resource level is set. The threshold resource level may be set by default in establishing the first data record. In one example, it may be set by administrative policy at the server. In another example, it may be set based on data analysis of past resource consumption patterns. In yet a further example, it may be set by the manager via the manager application.

In operation 404, the resources allocated to the first data record are compared to the threshold resource level to see if the allocated resources exceed the threshold. If so, then in operation 406 a surplus is identified. If not, then the system continues to monitor. In this example method, the threshold may be changed, so the method 400 may include determining whether a change has been requested and, if so, returning to operation 402 to set a new threshold resources level.

In another example, the system may identify surplus resources by determining that the resource consumption over a fixed period of time is lower than a determined resource consumption level for that period of time. FIG. 5 shows, in flowchart form, one example method 500 for identifying surplus resources based on consumption drops.

In operation 502, the system determines the resource usage or consumption associated with the first data record. The consumption is over a certain period of time, such as a day, a week, a month, etc. The consumption may be an average or a weighted average of the actual consumption over past time periods. The weighting may be used to more heavily weight recent time periods. In some cases, the average is over a window of a certain number of recent time periods. In some embodiments, the resource consumption level may be a pre-set or selected consumption level, rather than an empirically determined level.

Resource usage or consumption may be determined dependent upon the nature of the resources in question. In the case where the data record and resources are such that the resources allocated to the data record are consumed by the data record, such as in the case of processing resources being allocated to an application/thread/process requiring computing resources, then the consumption may be a measurement of the actual processor time or cycles or capacity required over the relevant time period. In certain cases, a more relevant measurement is peak usage, such as peak processor or memory requirements. However, in the case where the data record is a holder of resources for consumption in the sense for distributing the resources to external entities or locations for consumption, then the measurement of resource consumption may be a calculation of resources transferred or distributed out of the data record over that time period. Such may be the case where the resources are tokens representative of a quantifiable asset that may be transferred or distributed to other entities or nodes.

In operation 504, having determined the “usual” resource consumption rate per time period, the system may assess whether the consumption over the most recent time period is lower than the usual consumption level. That is, having determined a “normal” or “usual” or “average” resource consumption level, if the most recently completed time period featured resource consumption lower than the determined level, then surplus resources are identified. The quantity of the surplus may be, in some cases, based on the difference between the normal consumption level and the resources actually consumed over that time period.

In some example embodiments, resource replenishment, i.e. resource allocation to the data record, may be factored into the analysis of whether surplus resources are presently allocated to the data record. For example, in the case of tokens, credits, or the like, the allocation of resources to the data record may occur at regular or semi-regular intervals. For example, the data record may be allocated a particular quantity of resources every day, every week, every two weeks, every month, etc. Consumption of those resources may be less regular or fixed, meaning that at times the consumption may be less than the expected or actual allocation, leaving a surplus available. In some cases, the allocation may vary and extra resources may be allocated in certain time periods without a corresponding increase in consumption, leaving surplus resources available. These patterns of input and consumption may be evaluated to determine whether a surplus exists.

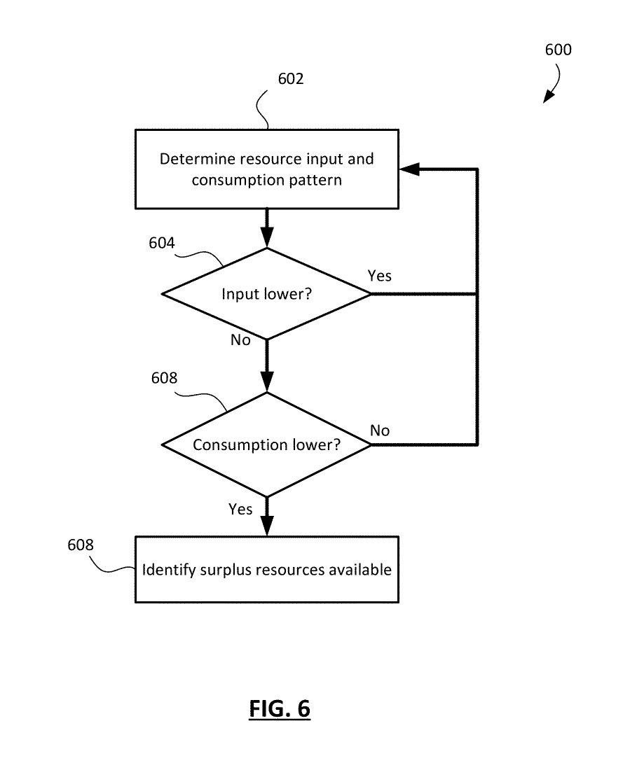

FIG. 6 shows, in flowchart form, one example method 600 of identifying surplus resources based on input and consumption. In this example method 600, a pattern of resource input and consumption is determined in operation 602. The pattern may be based on data analysis of the input and consumption associated with the first data record over a series of time periods, which may be days, weeks, months, etc. The time periods over which consumption is assessed may be based, in some instances, on the frequency with which resources are input. For example, if resources are regularly allocated to the first data record every week, then the corresponding consumption of resources between allocations may be assessed. Conversely, in some instances there may be a more fixed pattern of consumption, in which resources are consumed or output at fixed intervals in regular quantities, i.e. at a predictable rate. In such as case, variation in the resource input quantity or frequency may result in identification of surplus funds.

As one example, consider a cases in which resource replenishment (input) occurs in regular quantities in predictable increments. As an illustration, X tokens are input once every week. In this example, X/7 tokens are available for consumption per day in each week. At the end of a given week, if the average consumption is less than X/7 then surplus resources may be identified. In addition, part way through a week, the consumption per day may be determined to be lower than X/7 and, on that basis, it may be determined that surplus resources are available. That is, the system may not necessarily wait to the end of an increment to identify if surplus resources are available and may do so part way through an increment. In some cases, the system may project usage over a time period based on a drop in the rate of resource consumption during an earlier portion of the period and extrapolate the surplus resources available if that reduced consumption were continued over the remainder of the period.

In the example method 600 of FIG. 6, at operation 604, it may be determined whether the resource input is lower than would be predicted by the pattern determined in operation 602. If so, then a surplus is unlikely. In operation 606, it may be determined whether the resources consumed are lower than predicted by the pattern. If they are, then surplus resources are likely present and, in operation 608, the surplus resources are identified. It will be appreciated that, in various embodiments, operations 604 and 606 may be over a previous fixed time period or increment, or over a first portion of a time period or increment, as discussed above.

It will be appreciated that the resource allocation system may use a range of possible data analysis techniques taking into account resources consumed or present in a first data record and, in some cases, resource replenishment and resource usage patterns, to identify surplus resources. Variations in mechanisms for identifying surplus resources will be understood by those of ordinary skill in the art and are intended to be included and encompassed by the present description.

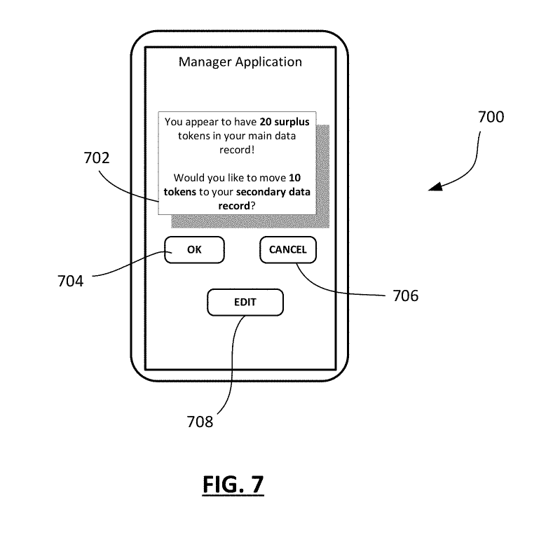

Reference is now made to FIG. 7, which diagrammatically illustrates an example remote device user interface 700. The user interface 700 is for the manager application executing on the remote device. In this example, the manager application has been launched or instantiated and presents the user interface 700 for display on the display screen of the remote device. The remote device display screen may be a touchscreen in some embodiments, such as the one illustrated, but is not necessarily a touchscreen in all embodiments.

As noted above, the server sends a notification to the remote device when surplus resources are identified in connection with a first data record with which the first device (or, more particularly, its manager application) is associated. The notification provides the remote device with information regarding the surplus resources and the proposed reallocation to a second data record. The proposed reallocation may be for the entire identified surplus resources or some portion of the surplus resources. As shown in FIG. 7, the user interface rendered by the manager application on the remote device presents the notification regarding surplus resources as a message 702. The notification may, in some implementations, be presented when received if the manager application is open. In some cases, the notification may be presented using a notification facility on the remote device when the manager application is closed. The presentation of the notification may depend on the operating system governing operation of the remote device. In some cases, if the notification is received without the manager application being opened such that authentication has occurred, then selecting the notification may prompt an authentication routine, such as user-password entry, biometric identification, or other such security measures.

The message 702 rendered on the remote device details the surplus resources identified, the first data record to which they are allocated, and the proposed reallocation details. The user interface 700 further includes selectable options to either approve the proposed reallocation, which in this example is an “OK” button 704, or to refuse the proposed reallocation, which in this example is a “CANCEL” button 706. In some cases, selection of the “OK” button 704 may lead to a further verification step that may or may not include further security measures for ensuring the user is authenticated, or may simply include an additional opportunity to confirm or cancel the proposed reallocation. In some implementations, a selectable option to alter the proposed reallocation may also be presented, which in this case is an “EDIT” button 708. Selection of the “EDIT” button 708 may provide an interface through which the details of the proposed reallocation are presented in editable form, enabling the user to modify the quantity of resources or the data record to which the surplus resources are to be reallocated.

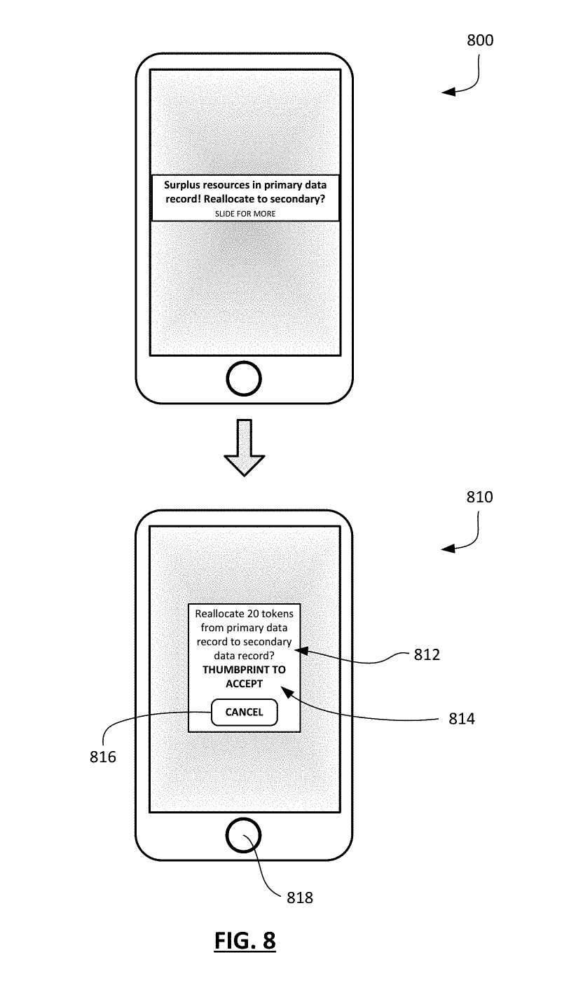

FIG. 8 shows another example user interface 800 for a remote device, which in this case is in a locked state when the notification is received. In this example, a notification message 802 is rendered atop the lockscreen displayed on the device when in locked mode. It will be appreciated that the precise details of the lockscreen behaviour and notification message 802 will partly depend on the operating system of the remoted device. In this example, the notification message 802 presents information regarding the identified surplus funds allocated to the first data record and may, space permitting, provide details regarding the proposed reallocation. In some cases, the user may be invited by the notification message 802 to take an action (e.g. tap, slide, keypress, etc.) to view additional information regarding the proposed reallocation.

FIG. 8 further shows a subsequent example user interface 810 to which the user interface 800 transitions after a user action in relation to the notification message 802. For example, if the notification message 802 invites the user to swipe or slide the notification message 802 to pursue the proposed reallocation, then detection by the remote device of that swipe or slide leads to generation of the subsequent example user interface 810. The subsequent example user interface 810, in this implementation, is also rendered on the lockscreen. In some cases, depending on the operation system of the remote device, this may involves launching the manager application in the background to process communications with the server, but leaving the remote device is a locked state. In some cases, the remote device may need to be unlocked to pursue the reallocation by presenting the manager application user interface.

In this example, the subsequent example user interface 810 displays reallocation information 812 that may, for example, provide details regarding the proposed reallocation of resources. The interface 810 further provides an approval prompt 814, which may provide instructions on how to approve the reallocation. In this example, the approval prompt 814 indicates that a valid thumbprint must be input through a fingerprint sensor 818 in order to authenticate the user and approve the proposed reallocation. The user interface 810 may further include a selectable cancel option 816. In this example, an “edit” option (not illustrated) may be also be provides, although in the case of a lockscreen-layered message the option of editing the proposed reallocation may require the unlocking of the device to perform edits to the proposed reallocation from within the manager application interface.

In the case of these example user interfaces 700, 800, 810, if the device receives authorization (that is validated) to proceed with the proposed reallocation, then the remote device prepares and sends messages to the server approving the proposed reallocation. The messages may include the details of the proposed reallocation, particularly if the reallocation has been modified. The messages are, in most implementations, protected using encryption and other security measures to guard against malicious manipulation of resource allocation. The server and, in particular, the resource allocation manager then implements the approved reallocation of resources.

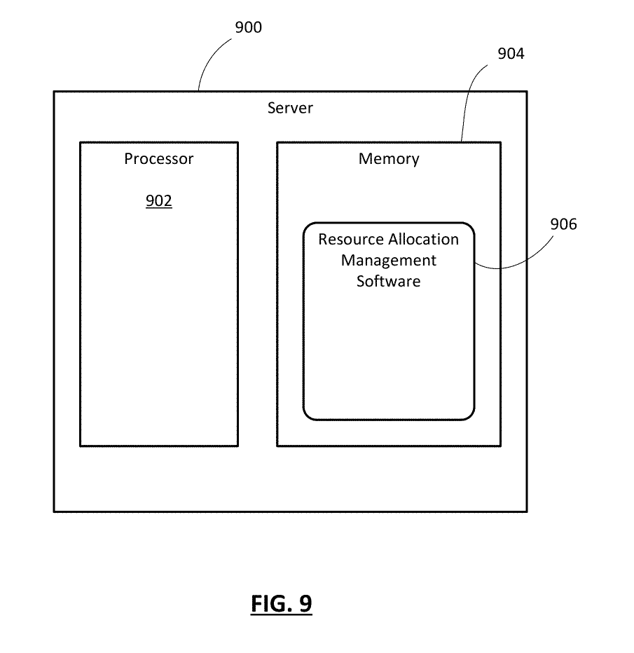

Reference is now made to FIG. 9, which shows, in block diagram form, one example server 900. The server 900 may include one or more processors 902 and memory 904. The memory 904 may store processor-executable software, such as resource allocation management software 906, that contains instructions implementing the operations and functions of the resource allocation system described above.

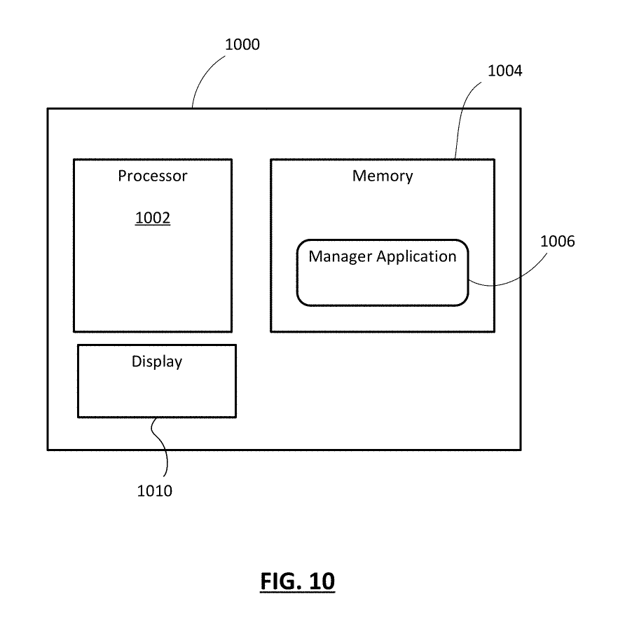

FIG. 10 illustrates, in block diagram form, one example of a remote device. The remote device is a computing device 1000. The computing device 1000 is equipped with a display 1010. In some embodiments, the computing device 1000 may be a portable electronic device. For example, the computing device 1000 may, as illustrated, be a smartphone. However, the computing device 1000 may be a computing device of another type such as a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays), and any other type of computing device that may be configured to store data and software instructions, and execute software instructions to perform operations consistent with disclosed embodiments. The computing device 1000 may be associated with one or more users which may interact with the computing device 1000. For instance, a user may operate the computing device 1000 such as by way of a provided graphical user interface whereby the computing device 1000 may perform one or more operations consistent with the disclosed embodiments.

The display 1010 may be any suitable manner of display such as, for example, a liquid crystal display (LCD), an e-ink/e-paper display, or the like. In some embodiments, the display 1010 may be a touchscreen display.

The computing device 1000 includes a processor 1002 and memory 1004. The memory 1004 may store processor-executable instructions in the form of software. The software may include an operating system to provide basic device functions, and may include application software. As an example, the memory 1004 may store a manager application 1006 that, when executed, performs the manager application operations and functions described above.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

Certain adaptations and modifications of the described embodiments can be made. Therefore, the above discussed embodiments are considered to be illustrative and not restrictive.

What is claimed is:

1. A system for proactively enabling reallocation of resources among two or more data records, the system comprising:
a processor;
memory coupled to the processor and storing the two or more data records, wherein the data records include a first data record to which resources are allocated; and
a resource allocation system, including processor executable instructions stored in the memory that, when executed, cause the processor to
determine that the resources allocated to the first data record include surplus resources,
send a notification to a manager application on a remote device, the manager application being associated with the first data record, the notification including a proposed reallocation of at least a portion of the surplus resources to a second data record associated with the manager application, and
receive a response confirming the proposed reallocation and, in response, reallocate the at least a portion of the surplus resources from the first data record to the second data record.

2. The system claimed in claim 1, wherein the processor is to determine by setting a threshold level of resources and determining that the resources allocated to the first data record exceed the threshold level.

3. The system claimed in claim 1, wherein the processor is to determine that the resources allocated to the first data record include surplus resources by determining that current resource consumption associated with the first data record is lower than previous resource consumption associated with the first data record.

4. The system claimed in claim 3, wherein the instructions, when executed, further cause the processor to determine the previous resource consumption as an average resource consumption over a time period, and determine the current resource consumption as a resource consumption over a most recent time period.

5. The system claimed in claim 1, wherein the processor is to determine by determining a resource input and a resource output pattern for the first data record, and either identifying that a resource input in a current time period is higher than the pattern or that a resource output in the current time period is lower than the pattern.

6. The system claimed in claim 1, further comprising:
the remote device having a display and storing the manager application, wherein the manager application, when executed on the remote device, displays the notification on the display, receives an input accepting the proposed reallocation, and transmits the response from the remote device.

7. The system claimed in claim 6, wherein displaying includes displaying the notification as an overlay to a lockscreen when the remote device is in a locked state, and the input includes an authentication operation to authenticate a user without unlocking the remote device.

8. The system claimed in claim 1, wherein the processor is configured to determine by determining that the second data record has not been configured, and wherein sending the notification includes prompting the manager application to authorize creation of the second data record and receiving authorization from the manager application to create the second data record associated with the manager application prior to reallocating the at least a portion of the surplus resources.

9. The system claimed in claim 1, wherein the resources include at least one of tokens, digital assets, computing resources, or currency.

10. A computer-implemented method of proactively enabling reallocation of resources among two or more data records, the data records include a first data record to which resources are allocated, the method comprising:
determining that the resources allocated to the first data record include surplus resources;
sending a notification to a manager application on a remote device, the manager application being associated with the first data record, the notification including a proposed reallocation of at least a portion of the surplus resources to a second data record associated with the manager application; and
receiving a response confirming the proposed reallocation and, in response, reallocating the at least a portion of the surplus resources from the first data record to the second data record.

11. The method claimed in claim 10, wherein determining includes setting a threshold level of resources and determining that the resources allocated to the first data record exceed the threshold level.

12. The method claimed in claim 10, wherein determining that the resources allocated to the first data record include surplus resources comprises determining that current resource consumption associated with the first data record is lower than previous resource consumption associated with the first data record.

13. The method claimed in claim 12, further comprising determining the previous resource consumption as an average resource consumption over a time period, and determining the current resource consumption as a resource consumption over a most recent time period.

14. The method claimed in claim 10, wherein determining includes determining a resource input and a resource output pattern for the first data record, and either identifying that a resource input in a current time period is higher than the pattern or that a resource output in the current time period is lower than the pattern.

15. The method claimed in claim 10, further comprising:
displaying the notification at the remote device;
receiving, at the remote device, an input accepting the proposed reallocation; and
transmitting the response from the remote device.

16. The method claimed in claim 15, wherein displaying includes displaying the notification as an overlay to a lockscreen when the remote device is in a locked state, and the input includes an authentication operation to authenticate a user without unlocking the remote device.

17. The method claimed in claim 10, wherein determining further includes determining that the second data record has not been configured, sending a notification includes prompting the manager application to authorize creation of the second data record and receiving authorization from the manager application to create the data record associated with the manager application prior to reallocating the at least a portion of the surplus resources.

18. The method claimed in claim 10, wherein the resources include at least one of tokens, digital assets, computing resources, and currency.

19. A non-transitory computer-readable storage medium storing instructions for proactively enabling reallocation of resources among two or more data records, the data records include a first data record to which resources are allocated, wherein the instructions, when executed by a processor of a computer system, cause the computer system to:
determine that the resources allocated to the first data record include surplus resources;
send a notification to a manager application on a remote device, the manager application being associated with the first data record, the notification including a proposed reallocation of at least a portion of the surplus resources to a second data record associated with the manager application; and
receive a response confirming the proposed reallocation and, in response, reallocate the at least a portion of the surplus resources from the first data record to the second data record.
